(19) United States
(12) Patent Application Publication
(10) Pub. No.: US 2003/0149623 A1
(43) Pub. Date: Aug. 7, 2003

(54) Method and apparatus for targeted marketing

(76) Inventor: Timothy Tianyi Chen, Athens, GA (US)

Correspondence Address: Thomas J. McWilliams, REEDSMITH LLP, 2500 One Liberty Place, 1650 Market Street, Philadelphia, PA, 19103-7301, US

(21) Appl. No.: 10/072,647

(22) Filed: Feb. 6, 2002

(51) Int. Cl. G06F 17/60

(52) U.S. Cl. 705/14

(57) ABSTRACT

A method of distributing advertisements to at least two potential respondents, and a system for providing an advertising program, are disclosed. The method includes recruiting at least one retailer to provide a plurality of advertisements, recording at least one profile of two potential respondents, providing at least one saver card to each potential respondent, targeting advertisements to a targeted at least one of the at least two potential respondents, and providing at least one transaction to the at least one targeted potential respondent upon response of the at least one targeted potential respondent to the targeted at least one advertisement. The system includes a program administrator in communication with at least one retailer, wherein the program administrator receives a recorded profile from at least one potential respondent to the advertising program, a message generator communicatively connected to the program administrator and to at least one of the at least one potential respondents, and a plurality of saver cards, wherein at least one of the saver cards is distributed to each of the at least one potential respondents.

### CROSS REFERENCE TO RELATED APPLICATIONS

N/A

### BACKGROUND OF THE INVENTION

1. Field of the Invention

The present invention is directed to the advertising, marketing, and sales of goods and services. More specifically, the present invention is directed to the offering of goods and services to consumers using targeted advertisements, and may include the measuring of the success of the targeted advertising.

2. Description of the Background

The Internet is a powerful source of communication. However, ventures to generate e-commerce over the internet often fail, or exhibit lackluster performance, including ventures involving bulk mail, national online mail orders, and advertisement links. Of companies that profit in e-commerce, many serve as the middle party between the customer and a retailer or vendor. Examples of this include bidding sites, such as Ebay® and Ubid®, and online ticket services such, as Priceline®, Travelocity®, and Expedia®. These middle-party sites do not incur retail and storage costs. Rather, these middle-party sites provide information, and extract profits from this provision of information.

Traditional Internet advertising, such as that using banners on websites, or pop-up browser windows, has not typically been successful. This may be attributed to the fact that once the novelty of using the advertisement website fades, there is nothing to remind consumers to return for information on additional bargains, savings or package deals. Additionally, it may be undesirable for potential buyers to purchase a product on-line, due to preferences of the potential buyer to physically measure the product's quality and appeal before purchasing the product. Thus, there exists a significant impediment to a customer purchase of items on-line in instances wherein the item cannot be inspected beforehand, or wherein the customer does not have prior knowledge of the item. Naturally, this impediment does not exist when a customer enters a conventional store, examines merchandise for sale, and purchases the item based on the examination.

Coupons, such as those from traditional paper advertisements, or from retail websites, have historically been a source of revenue generation for conventional and Internet stores. Coupons serve to bring attention to an establishment that advertises products through the coupons. However, large volumes of coupons may degrade the image of a business. Coupons may require newspaper, television, radio, magazine, or standalone store display investments by a retailer. Coupons may have expiration dates, and thus may require additional investment in paper printing to re-initiate discounts, thereby decreasing retailer efficiencies. Further, coupons with or without expiration dates may be abused by consumers through undesirable repeated use. Additionally, coupons require business employees to review additional paperwork while processing sales transactions, thereby decreasing employee efficiency and increasing customer inconvenience. Coupons have limited appeal, because coupons require significant effort on the part of the consumer to locate, clip and/or print out particular coupons for particular establishments. Also, there is a significant burden on the consumer to correlate and carry various coupons, dependent upon the particular establishments that the consumer is to visit. Moreover, there is historically no reminder to the consumer that updated or new coupons may exist for a particular establishment.

Therefore, there exists a need to dispense savings to consumers without the use of coupons, and to link the Internet with the convenience of a conventional brick and mortar store in an effective advertisement program that provides measurable marketing.

### SUMMARY OF THE INVENTION

The present invention is directed to a method of distributing advertisements to at least two potential respondents. The method includes recruiting at least one retailer to provide a plurality of advertisements, recording at least one profile of at least one of the at least two potential respondents, providing at least one saver card to each of the at least two potential respondents, targeting at least one of the plurality of advertisements to a targeted at least one of the at least two potential respondents, wherein the targeting is responsive to the at least one recorded profile of the targeted at least one potential respondent, and providing at least one transaction to the at least one targeted potential respondent upon response of the at least one targeted potential respondent to the targeted at least one advertisement. The response to the targeted at least one advertisement is evidenced by activation of the saver card associated with the recorded profile of the targeted at least one potential respondent.

The present invention is additionally directed to a system for providing an advertising program. The system includes a program administrator in communication with at least one retailer, wherein the program administrator receives a recorded profile from at least one potential respondent to the advertising program, a message generator communicatively connected to the program administrator and to at least one of the at least one potential respondents, and a plurality of saver cards, wherein at least one of the saver cards is distributed to each of the at least one potential respondents. The program administrator receives a first targeted advertisement from the at least one retailer, and the message generator generates a first message, in accordance with the first targeted advertisement, to a targeted at least one of the at least one potential respondents responsively to the recorded profile of the targeted at least one potential respondent. The program administrator receives an activation of the saver card of the targeted at least one potential respondent as a response to the first message.

Thus, the present invention dispenses savings to consumers without the use of coupons, and links the Internet with the convenience of a conventional brick and mortar store in an effective advertisement program that provides measurable marketing.

### BRIEF DESCRIPTION OF THE DRAWINGS

Understanding of the present invention will be facilitated by consideration of the following detailed description of an embodiment of the present invention taken in conjunction with the accompanying drawings, in which like numerals refer to like elements, and wherein:

FIG. 1 is a block diagram illustrating a system for providing a targeted marketing program;

FIG. 2 is a flow diagram illustrating a method of advertising, and of measuring the effectiveness of advertising;

FIG. 3 is a screen shot illustrating an exemplary registration screen for use in the present invention; and

FIG. 4 is a screen shot illustrating a front page of an administrator for use in the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical marketing or advertising method and system. Those of ordinary skill in the art will recognize that other elements are desirable and/or required in order to implement the present invention. However, because such elements are well known in the art, and because they do not facilitate a better understanding of the present invention, a discussion of such elements is not provided herein.

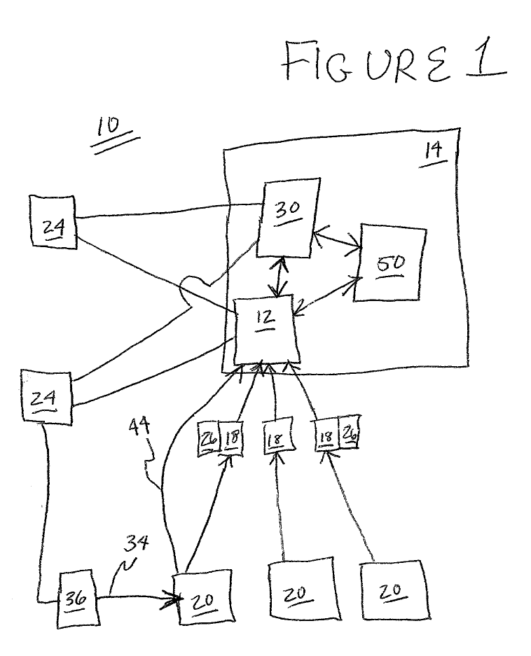

FIG. 1 is a block diagram illustrating a system 10 for providing a targeted marketing program. The system 10 includes targeted messages 12, such as e-mail messages, generated at a program administrator 14, wherein the messages 12 are generated in accordance with instructions 18 of at least one retailer 20, and wherein the targeted messages 12 are forwarded to a plurality of select customers 24, such as those csutomers that express a willingness to be in the program, wherein the select plurality 24 is determined based upon the target criteria 26 of at least one retailer 20. The select plurality of consumers 24 may respond to the messages 12, and/or may interact with the retailers 20, and/or may register for the program by initiating a profile 30, and/or may vary profile information, at the program administrator 14. The select customers 24 may have responses 34 to the targeted messages recorded, and may have profile information 30 varied, at the program administrator 14, via a validation card, or “saver card” 36, which saver card 36 is in communication with the program administrator 14. The present invention attracts customers to businesses by targeting select customers with discounts, sales, promotions, and other incentives.

The targeted messages 12 may be, for example, emails, telephone calls, internet messages, such as instant messages or “ping”s, mobile telephone messages, including short messaging, PDA messaging, or messages included in communication overhead, such as the overhead associated with television or cellular telephone communications. E-mail advertisements, for example, are highly selectable as to the desired recipient, easy to generate, and low in cost. Targeted messages 12 improve name recognition for businesses 20 in the program. However, it is preferable that the present invention not allow for “junk email”, wherein customers 24 are overwhelmed with targeted, or non-targeted, messages. The blockage of junk e-mail may result in less deletion of targeted advertisements by customers.

The program administrator 14 generates the targeted messages 12. The program administrator 14 may be, for example, a server, such as an internet server, and preferably includes accessibility to internet users, such as through a web page on the program administrator 14. The messages 12 are generated in accordance with instructions 18 of at least one retailer participating in the program, or of the administrator 14. Content may be varied by the retailer 20, by the administrator 14, or by the administrator at the instruction of the retailer. The retailer 20 may forward the instructions 18 for the formulation of advertising, and the criteria for desired target audience for the advertisement, to the program administrator 14. The retailer 20 may additionally forward the content of the advertisement 12 to the administrator 14, or the program administrator 14 may generate the advertisement 12 in accordance with the information received from the retailer. It is preferable that the administrator serve to interface the advertisements to the consumers.

In order to maintain interest of consumers 24 in the program, new advertisements 12 are preferably generated frequently, such as every two days. For example, the interval of receiving new advertisements via e-mail may be selected by a customer in the customer profile, by the retailer in the advertisement submission, or by the program administrator, at every day, every other day, specific days of the week, once a week, once a month, at specific times of the month, or at specific times of the year.

The program administrator 14 forwards the generated advertisement 12 to a plurality of select customers 24, wherein the select plurality 24 is determined based upon the target criteria in the instructions 18 from at least one retailer 20. For example, the retailer 20 may provide target criteria that all program participants having children, or that all program participants under age 21, or that 50% of program participants that responded to a previous advertisement from that retailer, receive the current advertisement 12. Thus, the target criteria 18 may include the buying history of the consumer 24. The recipients of the targeted message 12 are identified by the program administrator 14 by searching for program participants, i.e. customers 24, that meet the target criteria 18 according to the profile information 30 of those customers 24 entered at the program administrator 14. This profile information 30 may be generated by the customer 24, through registration, and/or subsequent data entry, at the program administrator site 14, and/or may be generated by tracking of customer responses at the program administrator 14. Profile information 30 may include address, age, salary, maximum number of advertisements per time period, interests, shopping habits, or the like.

The program administrator 14 may allow for the consumers 24 to respond to the messages 12, such as by making a purchase online through the program administrator 14, and/or may allow for interaction with the retailers 20, such as by providing hyperlinks to the retailers 20, and/or may allow for registration of the consumer 24 into the program by initiating a consumer profile 30, and/or may allow for a user to vary profile information 30. These interactions may, for example, be provided over an internet interface at the program administrator 14. Further, profile information 30 may, for example, be maintained at the program administrator 14 in at least one database, such as at least one relational database.

Additionally, responses 34 to the advertisements occurring at the retailer 20 providing the targeted advertisement 12 may be recorded at the program administrator 14, such as by the use of a saver card 36. The saver card 36 includes an identification of the customer 24 associated therewith, such as a magnetic strip, bar code, or identification number, and that customer identification is associated with the profile of that customer at the program administrator. Thus, the saver card 36 may be used at the participating retailer 20 to identify, to the program administrator 14, that a targeted customer 24 has engaged in the behavior desired to be elicited by the targeted advertisement 12, such as by entry of the identification of the customer 24 at the retailer 20, by a swipe or scan of the saver card, or by a like data entry, such as by manual entry, by the retailer 20. This identification is then preferably forwarded from the retailer 20 to the program administrator 14, such as over a communicative connection 44, or by manual entry by the administrator 14, thereby allowing the program administrator 14 to correlate the positive or negative response 34 of customers 24 to specific advertisements 12 received by the consumer 24. These correlations 50 may be sorted in any manner apparent to those skilled in the art, in order to produce reports to the at least one retailer of the effectiveness of the targeted advertisements 12, and to thereby allow for measuarable marketing. Further, data scanned from the saver card is recorded into the transaction record associated with that saver card, and into a transaction record associated with that retailer, wherein each of these transaction records is maintained within the program administrator. The transaction may include, for example, entry into the retailer store, a purchase in the retailer store, or receipt of a discount in the retailer store on a purchase.

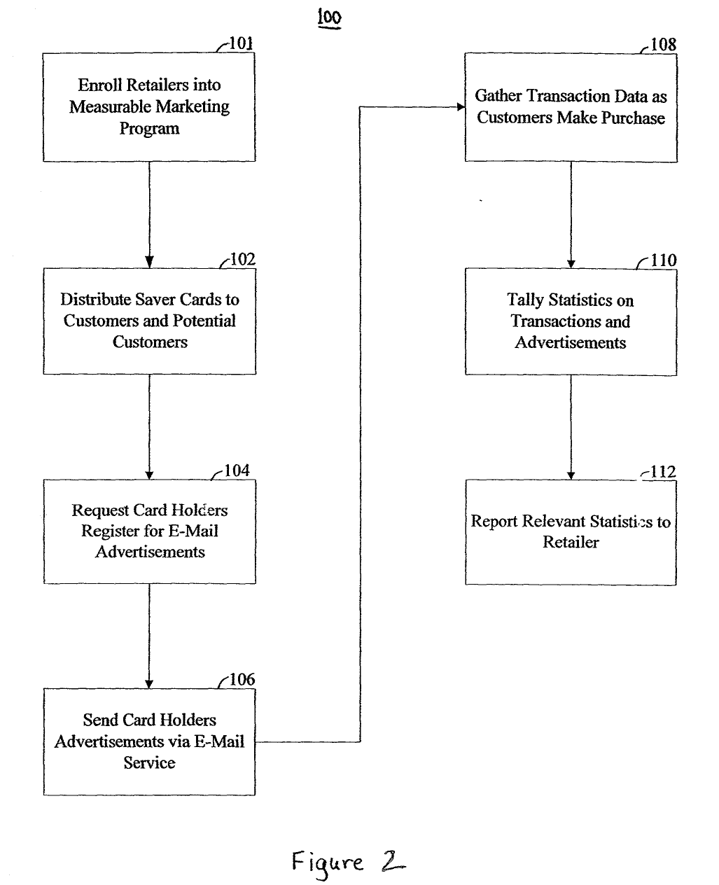

FIG. 2 is a flow diagram illustrating a method 100 of advertising, and of measuring the effectiveness of advertising. The method may include the steps of enrolling retailers into a measurable marketing program 101, distributing saver cards to customers and potential customers 102, requesting registration for targeted advertisements of holders of saver cards 104, sending targeted advertisements to registrants 106, monitoring purchase transactions resulting from the advertisements 108, statistical analysis of the transactions based on the advertisements 110, and the reporting of relevant statistics to the retailer 112.

At step 101, retailers may be enrolled into a measurable marketing program. In order to enroll, the retailer may, for example, pay an enrollment fee, and the retailer must additionally offer to provide value to customers through discounts or special deals available over a targeted advertising service. The enrollment fee may be, for example, a fixed price per month, such as $250, to allow for participation in the program. In the prior art, at a particular University, a local student newspaper charges $17 per square inch of advertising space per day. Therefore, an average advertisement may cost $300 for a 4″ by 5″ advertisement, per day, with no ability to measure return on the investment. The present invention thus provides improved capability to assess return on advertising investment, at a reduced cost over known advertising programs.

Suitable retailers may be assessed, or accessed, via any means known in the art, such as telephonically, via the Internet, via door-to-door sales, or the like. Suitable retailers may preferably be those retailers that are local to the customer base, or potential customer base, of the advertising system. Local businesses and retailers having greater familiarity with a local customer base will have an improved ability to assess the needs and desires of customers, and will thereby have an improved ability to target advertisements. Further, customers will most likely spend money for products and services in local communities before traveling to more distant shopping locations. Additionally, customers react most positively to advertisements of a business if the business is recognizable to the consumers. For example, the measurable marketing program may be implemented using local businesses and students at a University, and, in order to increase association by customers of the program with the local community, the mascot of the University may be used to provide a nomenclature for the saver card, such as the “Dawgsaver” student savings card for the University of Georgia Bulldogs. Other methodologies of increasing association of the program with the local community will be apparent to those skilled in the art. Areas surrounding a university present desirable localities for the implementation of the present invention, due to the fact that university students typically have access to the Internet and check e-mail frequently. The present invention is, however, readily expandable with respect to the participating retailers outside of a local community or local communities. Thus, the program may be expanded to a wide ranging audience, yet may be community-oriented in nature.

At step 102, saver cards are distributed to customers of the advertising system, and potential customers of the advertising system. A saver card may, for example, take the form of a keychain card or “credit card” type card, or other forms of identification that serve to identify members of the savers program, such as, but not limited to, a driver's license, bottle opener, such as a keychain bottle opener, or student identification card. Saver cards may be provided at no cost to the customer, or may be provided for a suitable fee to the customer. Saver cards may be provided by a business or retailer that is enrolled in the program, or may be provided by administrators of the advertising program. Alternatively, saver cards may be obtained in response to customer requests received via telephone, by the Internet, by e-mail, or by any additional means of receiving customer requests apparent to those skilled in the art. Saver cards may include thereon a methodology for data storage, such as a magnetic strip, or an integrated circuit memory chip. Alternatively, the saver card may have thereon printed a numeric or alphabetic key code, or a bar code, for tracking purposes of the card. Preferably, saver cards are distributed in pre-assessed markets wherein numerous of the suitable retailers are located proximately to the desired customer base. It will be apparent to those skilled in the art that saver cards may be distributed prior to the addition of retailers, or of new retailers, to the marketing program, or may be distributed at any point in the lifeline of the marketing program.

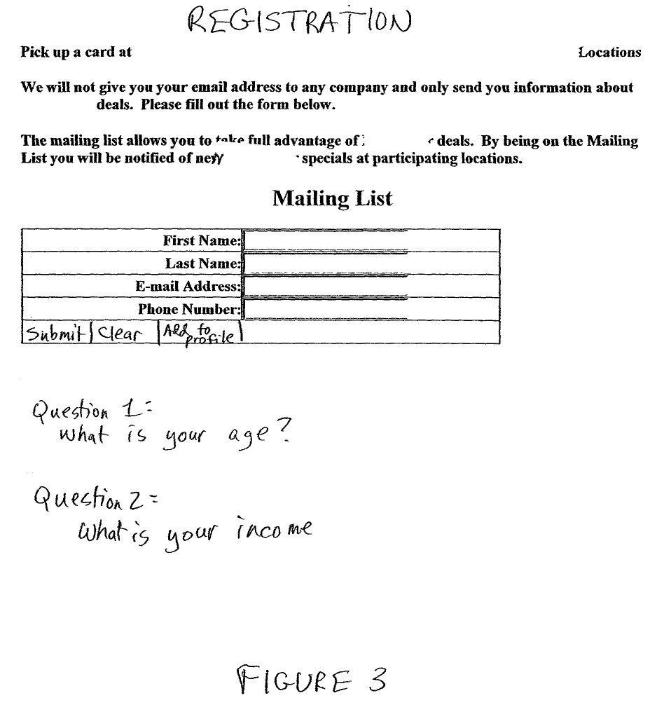

At step 104, customers holding the saver card may sign on to, for example, an Internet site associated with the marketing program, or an administrator thereof, in order to register as customers in the marketing program. A registration screen may be provided by the administrator of the program, such as the registration screen illustrated in FIG. 3. In a preferred embodiment, upon registration at the web site, the customer, and the saver card of that customer, will be associated with data within the marketing program. For example, the customer holding a saver card may enter personal information to allow for association of that customer with particular interests, such as interests in particular retailers. For example, the customer may enter a name, a local address, a telephone number, a series of hobbies, and/or may answer a series of profile questions, such as those related to eating and/or shopping habits. It will be apparent to those skilled in the art, any number of questions may be asked of the registering customer, that at least one question, preferably provides contact information sufficient to allow targeting of advertisements to the customer by the marketing program.

At step 106, and as a result of registration in step 104, targeted messages and advertisements are forwarded to the saver card holder. In one embodiment of the present invention, e-mail messages are employed in order to forward messages containing targeted offers or targeted advertisements from retailers to the saver card holders selected by those retailers as most likely to be responsive to the targeted offers for advertisements. For example, each retailer participating in the marketing program may provide a series of criteria from which customers to be associated with advertisements of that retailer are to be selected. Alternatively, retailers may provide variable criteria for the targeting of advertisement to customers, based on particular marketing efforts of the retailer.

In addition to the offering of discounts, such as special “last minute” discounts, to cardholders via e-mail, notification of deals at step 106 may be performed via the website of the program administrator. The website may, for example, feature hyperlinks to businesses, such as local businesses, that offer savings on the goods and services for registered users of the website. Accessing of these hyperlinks may provide additional information regarding a promotion, or may allow for the printing of, for example, an electronic coupon associated with the hyperlinked business. A targeted offer or advertisement preferably includes an enticement to the saver card holder to visit the retailer, and/or select or purchase a product or service of the retailer. The targeted messages may be generated by the administrator of the marketing program, with or without the instruction of at least one participating retailer or business, or may be provided to the system directly by the retailer via, for example, Internet web site connection, e-mail, telephone, or regular mail.

At step 108, transaction data is recorded as card holders visit retailers from which targeted messages were sent. The transaction data gathered may include, for example, that the customer performed a desired task in response to the message, such as visiting the retailer, or making a purchase from the retailer. At the point that the desired transaction occurs, the saver card of the user is preferably scanned, and/or manually entered by a party located at the retailer, in order to record into the marketing program that the desired transaction, due to the targeted message, has occurred. The merchant may, for example, swipe the card in a magnetic strip or bar code reader, or manually type in the letters and/or digits of an identification number. The mechanism for reading or entering the saver card identification information may be communicatively connected to the program administrator server via, for example, a modem, intranet, or internet link. Transaction data may include, for example, the time, date, amount of transaction, item purchased, service purchased, quantity purchased, retailer involved in the purchase, identification of the purchaser, proximity of receipt of the targeted messages from that retailer to that purchaser, and/or the success rate of targeted message from that retailer to that purchaser to-date. In one embodiment of the present invention, the information regarding identification of the purchaser may not be available directly to the retailer, and may be entered into the marketing program system in an encrypted, or otherwise secured, fashion. In this manner, the privacy of the customer may be protected. Nonetheless, it is preferred that the marketing program be enabled to track the identification of specific customers.

At step 110, statistical analysis of transactions is performed. The statistical analysis of transactions may occur, for example, after a suitable number of transactions have occurred, after a suitable time period, after a single transaction, or after a suitable number of advertisements, for example. The statistical analysis preferably provides information as to the success or failure of the marketing program. The criteria for success or failure may be generated by the marketing program, or may be generated by the retailer. The statistical analysis may include, for example, comparisons between the number of e-mail advertisements, or the timing of e-mail advertisements, to the number and/or timing of transactions that occur on behalf of card holders that receive the e-mail advertisements, in order to thereby derive a correlation between the advertisements and increased business to the retailer from the advertisements. The statistical analysis may additionally include a comparison of the return on investment of a given program of a retailer to other programs of that retailer, or to other programs of other retailers. Further, the statistical analysis may aid in the identification and/or targeting of particular markets, or market segments, for promotions. Thus, the success and/or probability of success of a marketing program is measurable due to the statistical analysis.

At step 112, the results of the statistical analysis are reported to the retailer. It will be apparent to those skilled in the art that either the retailer, or the administrator of the marketing program, may perform the statistical analysis and provide the report thereof to the retailer. Reports of the success, and/or failure, of marketing programs may periodically be provided, for example, in daily, weekly, monthly, quarterly, and/or yearly formats. Reports may be available to the retailer by, for example, regular mail, e-mail, or log-in and review on a web site of the administrator, or of the retailer. Alternatively, the data necessary to perform the analysis may be sent from the program administrator to the retailer, and the retailer can then correlate the data and/or formulate the reports, thereby allowing for increased specialization in the reports, and improved customer privacy due to the analysis of the data by fewer parties. In this alternative embodiment, the reading of the saver card may be linked directly to, for example, an on-site computer that performs data collection.

Upon correlation of specific advertisements and cardholder reaction, the success ratio of advertisements, or types of advertisements, may be gauged. The number of cardholders responding to the program at the specific business may be compared to the cost of advertisement, and a metric of business generated per dollar of advertising dollar may be thereby ascertained. In general, it is noted that the reports generated reflect that the stream of revenue from the marketing program of the present invention, correlated with the advertising costs, is substantially constant, due to the fact that the program of the present invention is not based on the number of hits on the website, or daily fluctuations in newspaper readership, for example.

The method of the present invention may additonally include, within the step of forwarding advertising to cardholders, the step of forwarding surveys to cardholders. These surveys may assist retailers and/or the program administrator in gaining desired information, such as information that improves the success of future promotions. Cardholders that complete the survey may receive a reward, such as a special, limited promotional message.

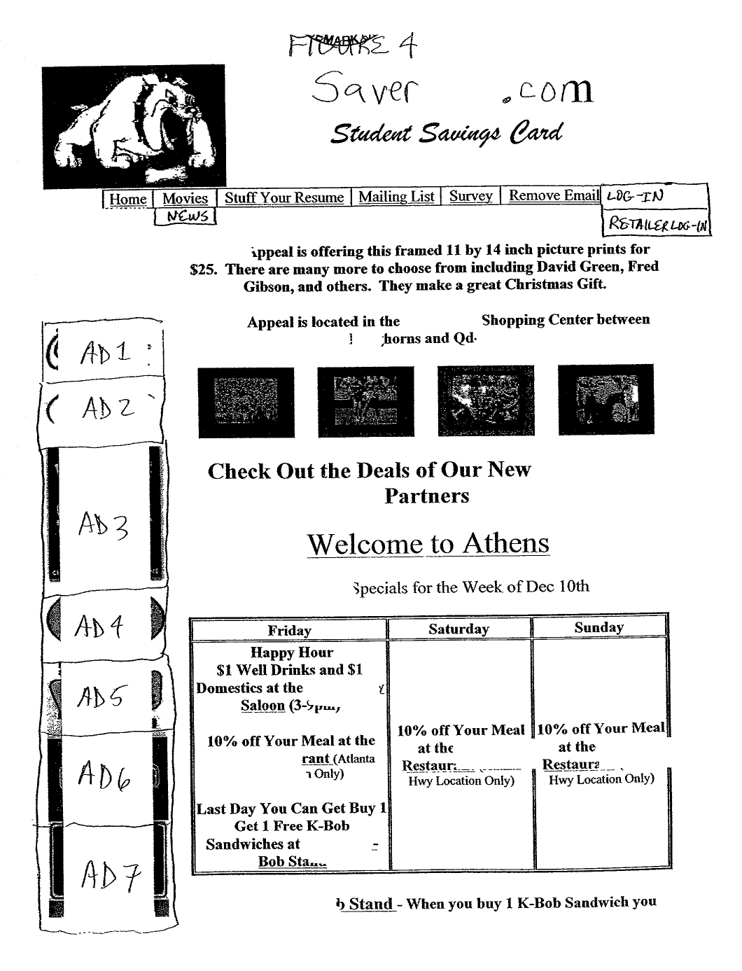

FIG. 4 is a screen shot illustrating a front page of an administrator for use in the present invention. The front page may provide for log-in of customers, and/or retailers, of the marketing program of FIGS. 1 and 2. Log-in to a web site may include, for example, a sign-on with a unique user name, identification number, or password, to the web site of the administrator. Further, log-in to the web site of the administrator may allow for the retailer to vary and/or change criteria for receipt of advertising from that retailer, or of content of the advertising of that retailer. Log-in for a customer may allow for generation, and/or variation, of that customer's profile.

The front page may provide, for example, services for customers and retailers, such as log-in for retailers or customers, listings of participating retailers, retailers assessed as being of particular interest to the particular then-logged-in customer based upon cookies on the computer of that customer, or other information of interest to the retailer or the customer, such as local news or classified advertsiements for low cost items. Log-in at the front page of the administrator of the marketing program web site may allow for the customer, and/or the retailer, to edit preferences, profile information, criteria, advertisement targeting or advertising content, as discussed hereinabove.

Those of ordinary skill in the art will recognize that many modifications and variations of the present invention may be implemented without departing from the spirit or scope of the invention. The foregoing description and the following claims are intended to cover all such modifications and variations.

What is claimed is:

1. A method of distributing advertisements to at least two potential respondents, comprising:
recruiting at least one retailer to provide a plurality of advertisements;
recording at least one profile of at least one of the at least two potential respondents;
providing at least one saver card to each of the at least two potential respondents;
targeting at least one of the plurality of advertisements to a targeted at least one of the at least two potential respondents, wherein said targeting is responsive to the at least one recorded profile of the targeted at least one potential respondent; and
providing at least one transaction to the at least one targeted potential respondent upon response of the at least one targeted potential respondent to the targeted at least one advertisement, wherein the response to the targeted at least one advertisement is evidenced by activation of the saver card associated with the recorded profile of the targeted at least one potential respondent.

2. The method of claim 1, further comprising:
gathering data of the at least one transaction of said providing at least one transaction.

3. The method of claim 2, wherein said gathering data comprises recording the data of the at least one transaction to the recorded profile of the targeted at least one potential respondent engaged in the transaction.

4. The method of claim 2, further comprising:
correlating the transaction data with said targeting, wherein said correlating generates advertisement effectiveness data.

5. The method of claim 4, further comprising:
repeatedly targeting effective advertisements, in accordance with the advertisement effectiveness data, to at least one repeatedly targeted of the targeted at least one of the at least two potential respondents.

6. The method of claim 2, wherein the transaction data comprises at least one of the group consisting of transaction time, transaction date, transaction amount, items purchased, retailer involved, and respondent identification.

7. The method of claim 1, wherein said recording comprises establishing an e-mail account for each of the potential respondents.

8. The method of claim 1, wherein said targeting comprises sending an email to at least one of the established e-mail accounts.

9. A system for providing an advertising program, comprising:
a program administrator in communication with at least one retailer, wherein the program administrator receives a recorded profile from at least one potential respondent to the advertising program;
a message generator communicatively connected to said program administrator, and to at least one of the at least one potential respondents;
a plurality of saver cards, wherein at least one of said plurality of saver cards is distributed to each of the at least one potential respondents;
wherein said program administrator receives a first targeted advertisement from the at least one retailer, and wherein said message generator generates a first message, in accordance with the first targeted advertisement, to a targeted at least one of the at least one potential respondents responsively to the recorded profile of the targeted at least one potential respondent, and wherein said program administrator receives an activation of the saver card of the targeted at least one potential respondent as a response to the first message.

10. The system of claim 9, wherein the first message is generated to the targeted at least one potential respondent in accordance with target criteria from the at least one retailer, wherein the target criteria is within the first target advertisement.

11. The system of claim 9, further comprising a correlator communicatively connected to said program administrator, wherein said correlator gathers transaction data of each saver card activation.

12. The system of claim 11, wherein said correlator updates the at least one recorded profile in accordance with the transaction data.

13. The system of claim 11, wherein said correlator generates advertisement effectiveness data in accordance with the transaction data.

14. The system of claim 11, wherein the transaction data comprises at least one of the group consisting of transaction time, transaction date, transaction amount, items purchased, retailer involved, and respondent identification.

15. The system of claim 1, wherein said saver card comprises one selected from the group consisting of a magnetic card, a bar code card, and a driver's license.
